(19) United States
(12) Patent Application Publication
(10) Pub. No.: US 2006/0276199 A1
(43) Pub. Date: Dec. 7, 2006

(54) Vehicle tracker having selectable transceiver mute mode and associated methods

(75) Inventor: Kenneth E. Flick, Douglasville, GA (US)

Correspondence Address: CHRISTOPHER F. REGAN, ESQUIRE;ALLEN, DYER, DOPPELT, MILBRATH & GILCHRIST, P.A., P.O. Box 3791, Orlando, FL, 32802-3791, US

(73) Assignee: Omega Patents, L.L.C., Douglasville, GA (US)

(21) Appl. No.: 11/143,181

(22) Filed: Jun. 2, 2005

(51) Int. Cl. H04Q 7/20

(52) U.S. Cl. 455/456.1; 455/345

(57) ABSTRACT

A vehicle tracking system for a vehicle may include a wireless transceiver that is switchable from a mute mode to an operational mode. The wireless transceiver when in the mute mode may receive signals from a communications network, but does not transmit signals to the communications network. The wireless transceiver when in the operational mode may receive and transmit signals with the communications network. A position-determining device at the vehicle may be for determining a geographic position thereof. A controller at the vehicle may be for switching the wireless transceiver from the mute mode to the operational mode based upon the vehicle position being outside a predetermined area. Alternately, The vehicle tracking system may include a switch at the vehicle, and the controller may switch the wireless transceiver from the mute mode to the operational mode based upon the switch.

### FIELD OF THE INVENTION

The invention relates to the field of vehicle devices, and, more particularly, to a tracking and alerting system for a vehicle and related methods.

### BACKGROUND OF THE INVENTION

Vehicle owners such as individuals and businesses often desire to know the location of their vehicle(s). A number of patents disclose various systems and approaches to tracking vehicles. For example, U.S. Pat. Nos. 6,297,768; 6,476,763; 6,484,035; and 6,710,738 to Allen, Jr. disclose a vehicle locator system wirelessly connected to a communications network. The vehicle locator system includes a controller connected to a Global Positioning System (GPS) receiver, a vehicle switch, and a wireless transceiver. The controller is asleep until the wireless transceiver or the vehicle switch sends a wake-up signal to the controller. The controller then reports the location of the vehicle via the wireless transceiver based upon the GPS receiver to a monitoring station connected to the communications network.

U.S. Pat. Nos. 6,737,989 and 6,844,827 to Flick disclose a vehicle tracking unit in communication with a cellular network and correspond to a commercial tracking device called the GPS 2000 available from Omega R&D, Inc. of Douglasville, Ga. The vehicle tracking unit includes a controller cooperating with a vehicle position-determining device and a wireless communications device to determine and send vehicle position information to a monitoring station connected to the cellular network. In addition, the controller may store a user selected reference location and send vehicle position information based upon the vehicle moving beyond a radial threshold distance from the user selected reference location. Moreover, the cellular transceiver, once initially activated, transmits and receives signals from the cellular network, thereby accruing usage charges.

U.S. Pat. Nos. 6,847,825 and 6,876,858 to Duvall et al. disclose a vehicle locator system including a vehicle tracking unit cooperating with a monitoring station via a communications network to locate a vehicle. The vehicle tracking unit includes a controller cooperating with a GPS receiver and a wireless transceiver. After a user calls the monitoring station, the monitoring station queries the vehicle tracking system via the communications network, which activates the GPS receiver. The activated GPS receiver determines the vehicle location and forwards this data to the monitoring station via the wireless transceiver using the communications network.

The Rimer '841 patent discloses a vehicle location system including a vehicle computer connected to a wireless transceiver that communicates with a communications network at regular intervals. The vehicle computer uses data generated from the wireless transceiver's communications with the communications network to determine the vehicle location and sends this information to a monitoring station connected to the communications network.

Unfortunately, one difficulty of such conventional tracking systems is that they typically continue to incur cellular charges after activation.

### SUMMARY OF THE INVENTION

In view of the foregoing background, it is therefore an object of the invention to provide a vehicle tracking system that reduces vehicle tracking system charges.

This and other objects, features, and advantages in accordance with the invention are provided by a vehicle tracking system for a vehicle that may include a wireless transceiver at the vehicle that is switchable from a mute mode to an operational mode. The wireless transceiver when in the mute mode may receive signals from a communications network, but does not transmit signals to the communications network. The wireless transceiver when in the operational mode may receive and transmit signals with the communications network. A position-determining device at the vehicle may be for determining a geographic position of the vehicle. A controller at the vehicle may be for switching the wireless transceiver from the mute mode to the operational mode based upon the position-determining device determining a vehicle position outside a predetermined area. Accordingly, a vehicle tracking system may be provided that reduces vehicle tracking system charges until a vehicle is moved outside of the predetermined area.

The controller may also switch the wireless transceiver from the operational mode back to the mute mode based upon the position-determining device determining the vehicle position is back within the predetermined area. The controller may cooperate with the wireless transceiver to transmit an alert message based upon the position-determining device determining the vehicle position is outside the predetermined area. The controller may further cooperate with the wireless transceiver to transmit vehicle geographic position data based upon the position-determining device determining the vehicle position is outside the predetermined area. The controller may periodically transmit the vehicle geographic position data, for example.

The communications network may comprise a cellular communications network, and the wireless transceiver may comprise a cellular telephone transceiver. The position-determining device may comprise a Global Positioning System (GPS) receiver.

The vehicle tracking system may further comprise a vehicle security sensor. The controller may cooperate with the vehicle security sensor to provide a vehicle security function. The controller may comprise a data bus interface for interfacing to a data communications bus extending throughout the vehicle.

Alternately, the vehicle tracking system may include a switch at the vehicle for switching the wireless transceiver from the mute mode to the operational mode. The switch may perform at least one other vehicle function, and the controller may switch the wireless transceiver from the mute mode to the operational mode based upon activation of the switch in a predetermined pattern. Additionally, the controller may switch the wireless transceiver from the operational mode to the mute mode based upon the switch.

A method aspect of the invention is directed to using a vehicle tracking system comprising a wireless transceiver at the vehicle being switchable from a mute mode to an operational mode. The wireless transceiver when in the mute mode receives signals from a communications network, but does not transmit signals to the communications network. The wireless transceiver when in the operational mode may receive and transmit signals with the communications network. The method may comprise using a position-determining device at the vehicle for determining a geographic position thereof. The method may further comprise switching the wireless transceiver from the mute mode to the operational mode, via a controller at the vehicle, based upon the position-determining device determining a vehicle position is outside a predetermined area.

Another method aspect of the invention is for using the vehicle tracking system with a switch at the vehicle. The method may comprise switching the wireless transceiver from the mute mode to the operational mode, via a controller at the vehicle, based upon the at least one switch.

### BRIEF DESCRIPTION OF THE DRAWINGS

FIG. 1 is a schematic block diagram of the vehicle tacking system according to the invention.

FIG. 2 is a schematic block diagram of an alternate embodiment of the vehicle tacking system according to the invention.

FIG. 3 is a schematic block diagram illustrating an exemplary threshold radius according to the invention.

FIG. 4 is a flowchart illustrating a method according to the invention.

FIG. 5 is a flowchart illustrating an alternate method according to the invention.

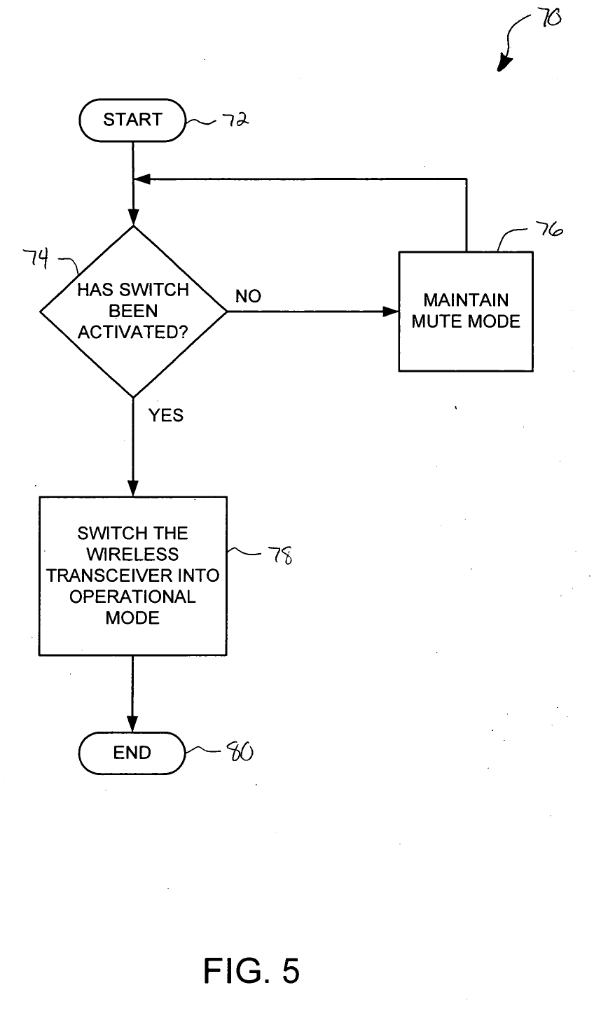

### DETAILED DESCRIPTION OF THE PREFERRED EMBODIMENTS

The invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, and prime notation is used to indicate similar elements in alternate embodiments.

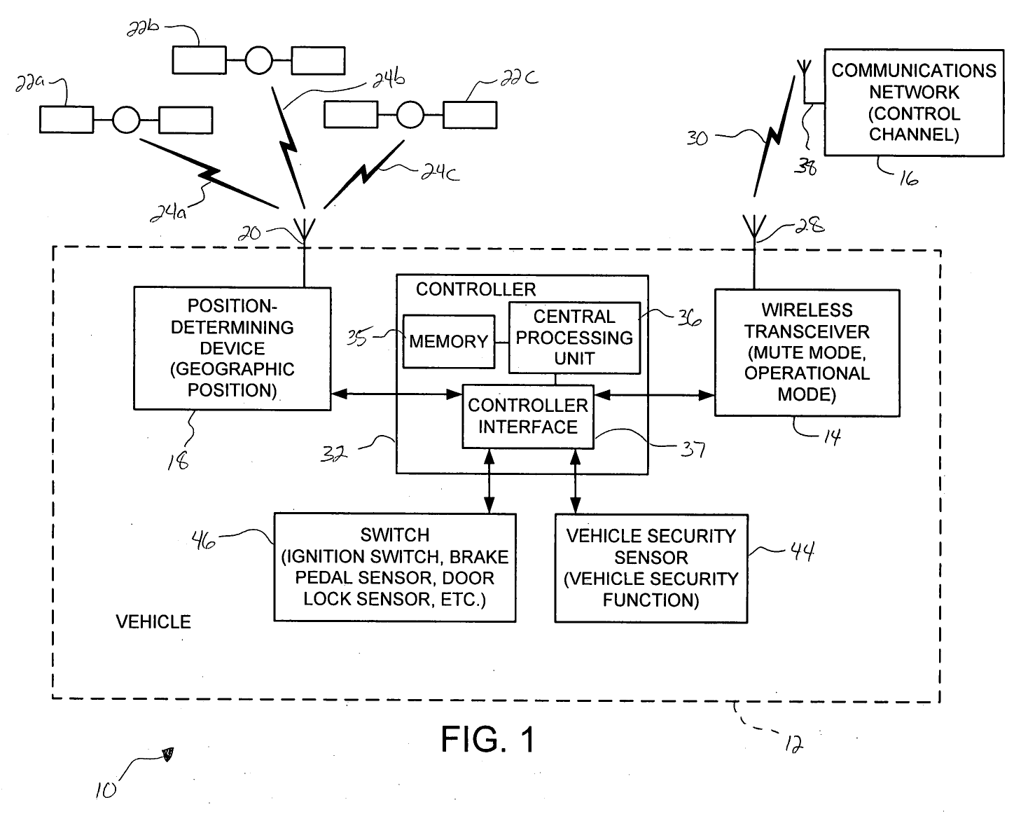

Referring initially to FIGS. 1-3, a vehicle tracking system 10 for a vehicle 12 in accordance with the invention is now described. The vehicle tracking system 10 includes a wireless transceiver 14 at the vehicle 12 that is switchable from a mute mode to an operational mode, for example. The wireless transceiver 14 uses an antenna 28 to communicate through an antenna 38 with a communications network 16 over a communications link 30. The communications network 16 may comprise a cellular communications network, and the wireless transceiver 14 may comprise a cellular telephone transceiver, for example.

The wireless transceiver 14 when in the mute mode receives signals from the communications network 16, but does not transmit signals to the communications network as will be appreciated by those of skill in the art. The wireless transceiver 14 when in the operational mode receives and transmits signals with the communications network 16. Since charges typically accrue upon transmission, in the mute mode these charges are saved. In addition, because the wireless transceiver 14 does not transmit in the mute mode, the communications network 16 is unaware that the vehicle tracking system 10 exists thereby preventing or eliminating a minimum monthly service fee.

A position-determining device 18 at the vehicle is for determining a geographic position of the vehicle 12. The position-determining device 18 may comprise a Global Positioning System (GPS) receiver. In this form, the position-determining device 18 uses an antenna 20 at the vehicle 12 to communicate with GPS satellites 22a-22c over communications links 24a-24c to determine the vehicle location, for example. Alternately, the position-determining device 18 may communicate with the communications network 16 over a communications link (not shown) using techniques such as triangulation and like to determine the vehicle location as will be appreciated by those of skill.

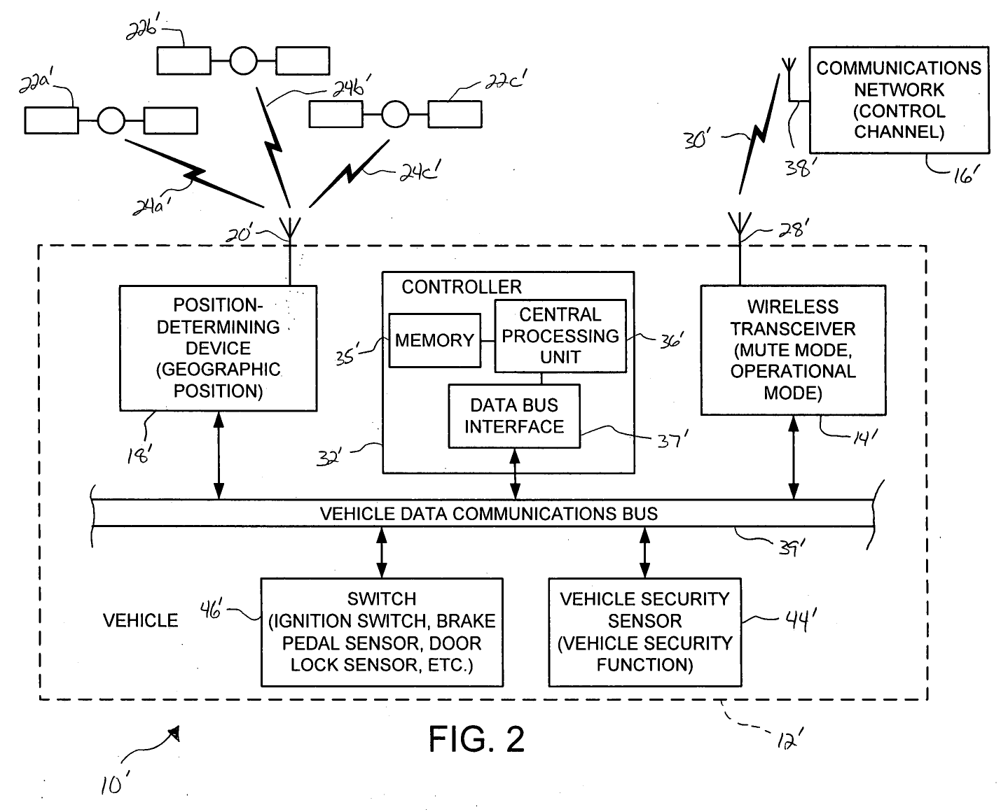

A controller 32 at the vehicle 12 includes a central processing unit 36 connected to a memory 35, and a controller interface 37 as will be appreciated by those of skill in the art. The controller interface 37 is for interfacing with other vehicle devices, for example. Alternately, the controller 32′ may comprise a data bus interface 37′ for interfacing to a data communications bus 39′ extending throughout the vehicle 12′ thereby permitting the controller to interface with other vehicle devices (FIG. 2). As will be appreciated by those of skill in the art, the controller 32 may interface with other vehicle devices using both the controller interface 37 and the data bus interface 37′.

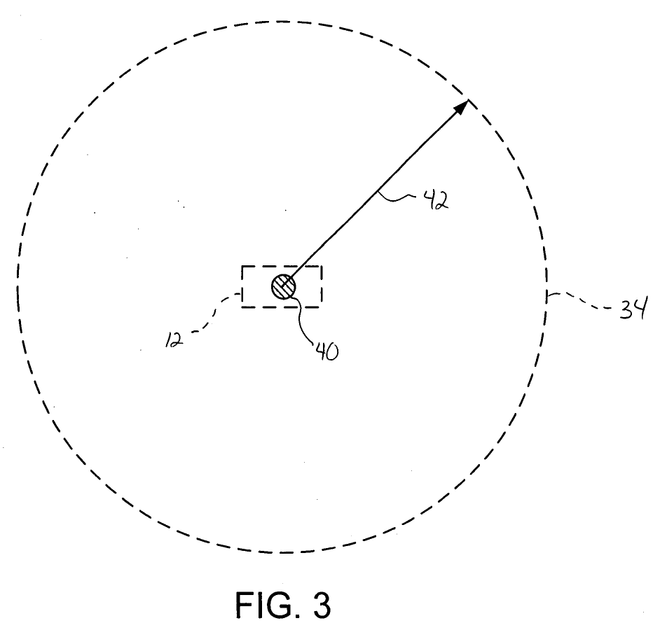

The controller 32 is for switching the wireless transceiver 14 from the mute mode to the operational mode based upon the position-determining device 18 determining a vehicle position outside a predetermined area 34 (FIG. 3). An example of a position-determining device 18 determining a vehicle position outside a predetermined area 34 is provided in U.S. Pat Nos. 6,737,989 and 6,844,827 to Flick, the entire disclosures of which are incorporated herein in their entirety by reference. Unfortunately, this prior art tracker accrues usage charges once activated.

The predetermined area 34 is defined by a threshold radius 42 that is set from a user selectable reference location 40, for example. Alternately, the predetermined area 34 may be defined using other techniques such as the entry of latitude and longitude coordinates so that the predetermined area 34 can have any shape as will be appreciated by those of skill in the art. Additionally, the predetermined area 34 may be a latitude and/or longitude line such as may be used to define a county or state line. Accordingly, a vehicle tracking system 10 is provided that may reduce vehicle tracking system charges.

The controller 32 may also cooperate with the wireless transceiver 14 to transmit an alert message based upon the position-determining device 18 determining the vehicle position is outside the predetermined area 34 as will be appreciated by those of skill in the art. For example, the alert message 36 is transmitted through the communications network 16 to a monitoring station, a vehicle owner, the police, or the like to notify such that the vehicle is not where it is supposed to be.

The controller 32 may further cooperate with the wireless transceiver 14 to transmit vehicle geographic position data based upon the position-determining device 18 determining the vehicle position is outside the predetermined area 34. The controller 32 may periodically transmit the vehicle geographic position data as will be appreciated by those of skill in the art. Additionally, the controller 32 may also switch the wireless transceiver 14 from the operational mode back to the mute mode based upon the position-determining device 18 determining the vehicle position is back within the predetermined area 34.

The vehicle tracking system 10 may further comprise a vehicle security sensor 44 such as a door pin switch, motion sensor, etc. The controller 32 may cooperate with the vehicle security sensor 44 to provide a vehicle security function.

Alternately or additionally, the vehicle tracking system 10 may include a switch 46 at the vehicle 12. The controller 32 at the vehicle 12 is then for switching the wireless transceiver 14 from the mute mode to the operational mode based upon the switch 46, for example. The controller 32 may switch the wireless transceiver 14 from the mute mode to the operational mode based upon activation of the switch 46 in a predetermined pattern. The switch 46 may be at least one of an ignition switch, a brake pedal sensor, a door lock sensor, or the like and the activation may be a predetermined sequence of activating such switches. One such sequence may be one turn of the ignition switch followed by multiple depressions of the brake pedal, for example. Additionally, the controller 32 may switch the wireless transceiver 14 from the operational mode to the mute mode based upon the at least one switch 46.

A method aspect of the invention is directed to using the vehicle tracking system 10 and is now described with reference to the flowchart 50 of FIG. 3. The method is for switching the wireless transceiver 14 at the vehicle 12 from a mute mode to an operational mode. The method starts at Block 52 and comprises using the position-determining device 18 at the vehicle 12 for determining a geographic position thereof at Block 54. The geographic position of the vehicle 12 is compared with the threshold radius 34 at Block 56. If the vehicle is within the threshold radius 34, then the mute mode of the wireless transceiver 14 is maintained at Block 58. If the position-determining device 18 determines that the vehicle 12 is outside the threshold radius 34, the controller 32 switches the wireless transceiver 14 from the mute mode to the operational mode at Block 60. The method ends at Block 62.

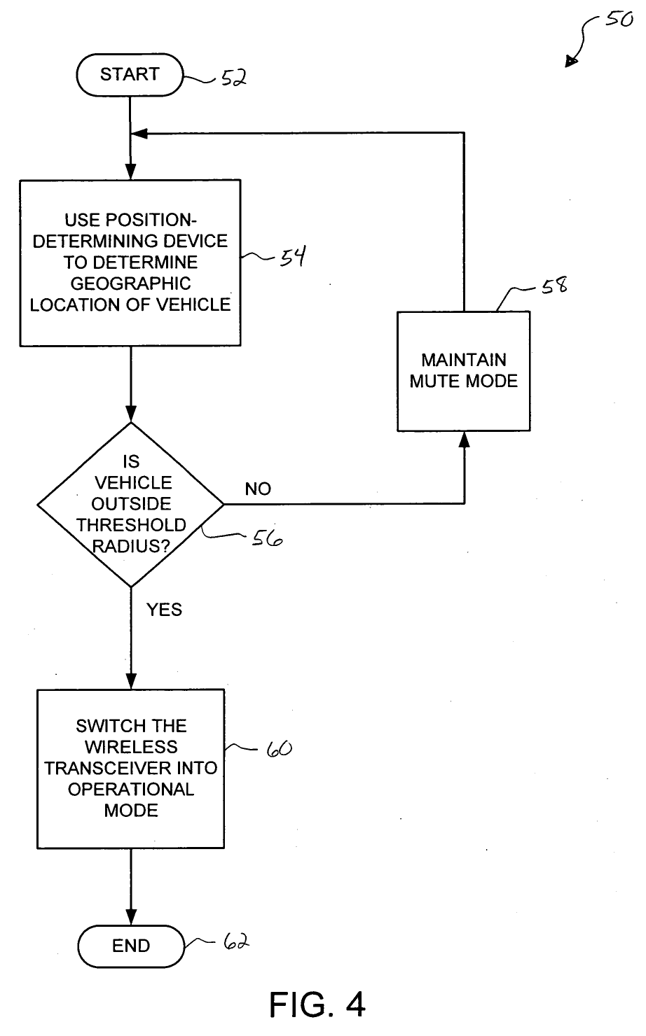

Another method aspect of the invention is now described with reference to flowchart 70 of FIG. 4. The method begins at Block 72 and is for using the vehicle tracking system 10 with the switch 46. The method comprises determining if the switch has been activated at Block 74. If the switch 46 has not been activated, then the mute mode of the wireless transceiver 14 is maintained at Block 76. If the switch 46 has been activated, the controller 32 switches the wireless transceiver 14 from the mute mode to the operational mode based upon the switch at Block 78. The method ends at Block 80.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that other modifications and embodiments are intended to be included within the scope of the appended claims.

That which is claimed is:

1. A vehicle tracking system for a vehicle comprising:
a wireless transceiver at the vehicle and being switchable from a mute mode to an operational mode, said wireless transceiver when in the mute mode receiving signals from a communications network but not transmitting signals to the communications network, said wireless transceiver when in the operational mode receiving and transmitting signals with the communications network;
a position-determining device at the vehicle for determining a geographic position thereof; and
a controller at the vehicle for switching said wireless transceiver from the mute mode to the operational mode based upon said position-determining device determining a vehicle position outside a predetermined area.

2. The vehicle tracking system according to claim 1 wherein said controller also switches said wireless transceiver from the operational mode back to the mute mode based upon said position-determining device determining the vehicle position is back within the predetermined area.

3. The vehicle tracking system according to claim 1 wherein said controller cooperates with said wireless transceiver to transmit an alert message based upon said position-determining device determining the vehicle position outside the predetermined area.

4. The vehicle tracking system according to claim 3 wherein said controller further cooperates with said wireless transceiver to transmit vehicle geographic position data based upon said position-determining device determining the vehicle position outside the predetermined area.

5. The vehicle tracking system according to claim 4 wherein said controller periodically transmits the vehicle geographic position data.

6. The vehicle tracking system according to claim 1 wherein the communications network comprises a cellular communications network; and wherein said wireless transceiver comprises a cellular telephone transceiver.

7. The vehicle tracking system according to claim 1 wherein said position-determining device comprises a Global Positioning System (GPS) receiver.

8. The vehicle tracking system according to claim 1 further comprising at least one vehicle security sensor; and wherein said controller cooperates with said at least one vehicle security sensor to provide at least one vehicle security function.

9. The vehicle tracking system according to claim 1 wherein said controller comprises a data bus interface for interfacing to a data communications bus extending throughout the vehicle.

10. A vehicle tracking system for a vehicle comprising:
a wireless transceiver at the vehicle and being switchable from a mute mode to an operational mode, said wireless transceiver when in the mute mode receiving signals from a communications network but not transmitting signals to the communications network, said wireless transceiver when in the operational mode receiving and transmitting signals with the communications network;
at least one switch at the vehicle; and
a controller at the vehicle for switching said wireless transceiver from the mute mode to the operational mode based upon said at least one switch.

11. The vehicle tracking system according to claim 10 wherein said at least one switch performs at least one other vehicle function; and wherein said controller switches said wireless transceiver from the mute mode to the operational mode based upon activation of said at least one switch in a predetermined pattern.

12. The vehicle tracking system according to claim 10 further comprising a position-determining device at the vehicle and connected to the controller for determining a geographic position of the vehicle.

13. The vehicle tracking system according to claim 12 wherein said position-determining device comprises a Global Positioning System (GPS) receiver.

14. The vehicle tracking system according to claim 10 wherein the communications network comprises a cellular communications network; and wherein said wireless transceiver comprises a cellular telephone transceiver.

15. The vehicle tracking system according to claim 10 further comprising at least one vehicle security sensor; and wherein said controller cooperates with said at least one vehicle security sensor to provide at least one vehicle security function.

16. The vehicle tracking system according to claim 10 wherein said controller also switches said wireless transceiver from the operational mode back to the mute mode based upon said at least one switch.

17. The vehicle tracking system according to claim 10 wherein said controller comprises a data bus interface for interfacing to a data communications bus extending throughout the vehicle.

18. A method for using a vehicle tracking system comprising a wireless transceiver at the vehicle being switchable from a mute mode to an operational mode, the wireless transceiver when in the mute mode receiving signals from a communications network but not transmitting signals to the communications network, the wireless transceiver when in the operational mode receiving and transmitting signals with the communications network, the method comprising:
using a position-determining device at the vehicle for determining a geographic position thereof; and
switching the wireless transceiver from the mute mode to the operational mode, via a controller at the vehicle, based upon the position-determining device determining a vehicle position outside a predetermined area.

19. The method according to claim 18 wherein the controller also switches the wireless transceiver from the operational mode back to the mute mode based upon the position-determining device determining the vehicle position is back within the predetermined area.

20. The method according to claim 18 further comprising using the wireless transceiver to transmit an alert message based upon the position-determining device determining the vehicle position outside the predetermined area.

21. The method according to claim 18 further comprising using the wireless transceiver to transmit vehicle geographic position data based upon the position-determining device determining the vehicle position outside the predetermined area.

22. The method according to claim 18 wherein the communications network comprises a cellular communications network; and wherein the wireless transceiver comprises a cellular telephone transceiver.

23. The method according to claim 18 wherein the position-determining device comprises a Global Positioning System (GPS) receiver.

24. The method according to claim 18 further comprising providing at least one vehicle security function.

25. The method according to claim 18 wherein the controller comprises a data bus interface for interfacing to a data communications bus extending throughout the vehicle.

26. A method for using a vehicle tracking system comprising a wireless transceiver at the vehicle being switchable from a mute mode to an operational mode, the wireless transceiver when in the mute mode receiving signals from a communications network but not transmitting signals to the communications network, the wireless transceiver when in the operational mode receiving and transmitting signals with the communications network, and at least one switch at the vehicle, the method comprising:
switching the wireless transceiver from the mute mode to the operational mode, via a controller at the vehicle, based upon the at least one switch.

27. The method according to claim 26 wherein the at least one switch performs at least one other vehicle function; and wherein the controller switches the wireless transceiver from the mute mode to the operational mode based upon activation of the at least one switch in a predetermined pattern.

28. The method according to claim 26 further comprising a position-determining device at the vehicle and connected to the controller for determining a geographic position of the vehicle.

29. The method according to claim 28 wherein the position-determining device comprises a Global Positioning System (GPS) receiver.

30. The method according to claim 26 wherein the communications network comprises a cellular communications network; and wherein the wireless transceiver comprises a cellular telephone transceiver.

31. The method according to claim 26 further comprising at least one vehicle security sensor; and wherein the controller cooperates with the at least one vehicle security sensor to provide at least one vehicle security function.

32. The method according to claim 26 further comprising providing at least one vehicle security function.

33. The method according to claim 26 wherein the controller also switches the wireless transceiver from the operational mode back to the mute mode based upon the at least one switch.

34. The method according to claim 26 wherein the controller comprises a data bus interface for interfacing to a data communications bus extending throughout the vehicle.
